(19) United States
(12) Patent Application Publication
(10) Pub. No.: US 2025/0326280 A1
(43) Pub. Date: Oct. 23, 2025

(54) MODULAR TRUCK BED TONNEAU COVER

(71) Applicants: STEVE LIVNEH, NORTHGLENN, CO (US); JIANGSU RONG FU KANG MEDICAL INSTRUMENTS CO. LTD., West Jiangyin City (CN)

(72) Inventor: STEVE LIVNEH, NORTHGLENN, CO (US)

(73) Assignee: JIANGSU RONG FU KANG MEDICAL INSTRUMENTS CO. LTD., West Jiangyin City (CN)

(21) Appl. No.: 18/870,651

(22) PCT Filed: May 31, 2023
(86) PCT No.: PCT/US2023/024028

§ 371 Date: Nov. 30, 2024

Related U.S. Application Data
(60) Provisional application No. 63/473,461, filed on May 31, 2022.

(51) Int. Cl. B60J 7/14

(52) U.S. Cl. CPC B60J 7/141

(57) ABSTRACT

A modular tonneau cover includes two longitudinal and foldable doors, each door including two hinged longitudinal sections. The cover, when flat, is operable to cover the open top beds of trucks. The doors are supported and lockable by three fixed beam assemblies attached to the front and sidewalls of the bed and by a removable beam assembly over the tailgate. Each door may be folded to the side or towards the center of the bed or re-flattened within the beams' framework using locking pins. The folding movement of the doors' is assisted by pinions rolling on racks within the front and tailgate beams. When the desired position of the door is reached, the pins are extended into locking holes.

### CROSS-REFERENCE TO RELATED APPLICATION

The instant application claims priority to U.S. Provisional Patent Application Ser. No. 63/473,461, filed May 31, 2022, pending, the entire specification of which is expressly incorporated herein by reference.

### FIELD OF THE INVENTION

The present invention relates generally to tonneau covers for the beds of motor vehicles, and more particularly, to tonneau covers for the beds of motor vehicles that include two longitudinal and foldable doors, each door including two hinged longitudinal sections, wherein the cover, when flat, may be operable to cover the open top beds of trucks, and wherein the doors are supported and lockable by three fixed beam assemblies attached to the front and sidewalls of the bed and by a removable beam assembly over the tailgate.

### BACKGROUND OF THE INVENTION

Pickup trucks are some of the bestselling motor vehicles sold in the United States, as well as in some other countries, with steady growth in popularity. Pickup trucks have become a multi-purpose/lifestyle vehicle, serving businesses, families and leisure needs. In essence, most pickup trucks sold these days come with crew cabs (i.e., a passenger cabin portion) and a bed portion, also known as a box. The bed is what makes a pickup truck so useful and popular, as it allows the owner to haul a variety of items from bulk goods (e.g., sand, gravel, etc.) to large objects such as furniture, machinery, ATVs and so forth.

The majority of truck owners opt for a bed cover, also known as a tonneau cover (hereinafter abbreviated as “TC”) for weather protection and added theft protection to the truck bed's contents. The majority of owners opt for a flat TC for various reasons like preserving most of the original truck's appearance and gaining weather protection and added security for items that can be stored out of sight under the flat TC.

Some other owners are opting for a full cover, usually at the height of the top (or nearly the top) of the passengers' cabin and extending essentially all the way to the bed's tailgate portion. As such, the owner gains added cargo volume with reasonable weather protection and added security. The relatively low popularity of this type of cover may be explained by various factors. The main one is reduced accessibility to the box as the low roofline makes it difficult to retrieve or load items in the distal portion of the box, e.g., near the passenger cabin. Many potential users have aesthetic reservations and worries related to the reduced security as these covers typically come with windows, at least above the tailgate, to allow rearward viewability to the driver. This exposes the contents to potential theft and reduced privacy.

Many attempts have been made through the years to add functionality to the truck's bed, anywhere from various tonneau covers to tool and storage boxes in various shapes and designs.

Accordingly, there exists a need for new and improved tonneau cover designs and systems that overcome the aforementioned deficiencies in the prior art.

### SUMMARY OF THE INVENTION

The present invention advances the functionality of the truck bed much further than the prior art. The modular TC system herein provides for weather protection, security and the ability to convert the TC such that partial or full access and usage of the bed may be enabled with a high degree of convenience and practicality.

The present invention herein discloses a new TC design, comprised of two longitudinal doors. The doors can be folded and locked on the bed's side walls such that the truck bed may be used wholly, as if the TC is absent. At the same time, the folded doors allow good rearward visibility to the driver. For example, once a large load is unloaded, the TC can be unfolded and return to its prior form within seconds.

Further, this modular design allows for quick exposure and access of each, or both of the longitudinal halves of the bed, by folding either the right or left TC doors towards the center of the box. This feature provides superior practicality and usefulness to the user. This feature would be highly valued by all users who seek instantaneous access to the truck bed's section from the side, like when parked parallel to the sidewalk, even without opening the tailgate, such as access to tool boxes or long items stored on either side of the box.

In accordance with the general teachings of the present invention, a modular tonneau cover is comprised of two longitudinal and foldable doors, wherein each door is comprised of two hinged longitudinal sections. The cover, when flat, is intended to cover the open top beds of trucks. The doors are supported and lockable by three fixed beam assemblies attached to the front and sidewalls of the bed and by a removable beam assembly over the tailgate. Each door may be folded to the side or towards the center of the bed or re-flattened within the beams' framework, for example, using locking pins. The folding movement of the doors' is assisted by pinions rolling on racks within the front and tailgate beams. Both pairs of corner pinions are connected by a rotatable rigid shaft. The locking pins within the rotatable shafts may retreat out of their respective locking holes, while still remaining within the pinions, thus allowing the folding or re-flattening of the doors. When the desired position of the door is reached, the pins are extended into locking holes. The doors may be locked in a flat position, thus protecting the bed's contents, or folded and locked sideways, thus providing unobstructed loading and unloading of the bed, or folded towards the center, thus providing convenient access to a half of the longitudinal portion of the bed.

The present invention provides three main embodiments: (1) an all mechanical/manual embodiment; (2) a manual operation with solenoid-actuator assisted locking pins; and (3) a motorized embodiment with automated center-folding and re-flattening together with manual side folding of the doors.

In accordance with a first embodiment of the present invention, a tonneau cover assembly for a vehicle is provided, wherein the vehicle includes a passenger compartment, an open bed portion and a tailgate portion, comprising:
a first beam member attached to an upper surface of the bed portion;
wherein the first beam member includes an area defining a track formed therein;
wherein the first beam member includes an area defining an aperture formed in a surface thereof;
a first door assembly operable to cover at least a portion of the open bed portion;
wherein the first door assembly includes first and second door members;
wherein the first and second door members are hingedly interconnected so as to be operable to rotate about one another;
wherein at least one of the first and second door members includes a pin member received within a pinion member;
wherein the pinion member is operable to be received within the track and rotate on a toothed rack within the track;
wherein the pin member is operable to be received within and retracted from the aperture; and
an actuation member operably associated with the pin member;
wherein when the actuation member is in a first mode of operation, the pin member is received within the aperture so as to prevent the first and second door members from rotating about one another;
wherein when the actuation member is in a second mode of operation, the pin member is retracted from the aperture so as to allow the first and second door members to rotate about one another.

In accordance with one aspect of the first embodiment, the tonneau cover assembly for a vehicle further comprises:
a second beam attached to a spaced and opposed upper surface of the bed portion proximate to the tailgate portion;
wherein the second beam member includes an area defining a track formed therein;
wherein the second beam member includes an area defining an aperture formed in a surface thereof;
wherein the pinion member is operable to be received within the track of the second beam member and rotate a toothed rack within the track;
wherein the pin member is operable to be received within and retracted from the aperture of the second beam member;
wherein when the actuation member is in a first mode of operation, the pin member is received within the aperture of the second beam member so as to prevent the first and second door members from rotating about one another;
wherein when the actuation member is in a second mode of operation, the pin member is retracted from the aperture of the second beam member so as to allow the first and second door members to rotate about one another.

In accordance with one aspect of the first embodiment, the tonneau cover assembly for a vehicle further comprises:
a third beam member attached to a left upper surface of the bed portion; and
a fourth beam member attached to a spaced and opposed right upper surface of the bed portion.

In accordance with one aspect of the first embodiment, the tonneau cover assembly for a vehicle further comprises:
a second door assembly operable to cover a second portion of the open bed portion;
wherein the second door assembly includes third and fourth door members;
wherein the third and fourth door members of the second door assembly are hingedly interconnected so as to be operable to rotate about one another;
wherein at least one of the third and fourth door members of the second door assembly includes a pin member received within a pinion member;
wherein the pinion member is operable to be received within the tracks of the first and second beam members and rotate a toothed rack within the track;
wherein the pin member is operable to be received within and retracted from the apertures of the first and second beam members; and
a second actuation member operably associated with the pin member;
wherein when the second actuation member is in a first mode of operation, the pin member is received within the apertures of the first and second beam members so as to prevent the third and fourth door members of the second door assembly from rotating about one another;
wherein when the second actuation member is in a second mode of operation, the pin member is retracted from the apertures of the first and second beam members so as to allow the third and fourth door members of the second door assembly to rotate about one another.

In accordance with one aspect of the first embodiment, the first and second door members of the first door assembly are operable to be rotated about one another so as to be positioned towards the left or right portion of the bed portion.

In accordance with one aspect of the first embodiment, the first and second door members of the first door assembly are operable to be rotated about one another so as to be positioned towards a centerline of the bed portion.

In accordance with one aspect of the first embodiment, the second beam is hingedly attached to the upper surface of the bed portion proximate to the tailgate portion.

In accordance with one aspect of the first embodiment, the tonneau cover assembly for a vehicle further comprises a center support member, wherein a lower portion is fastened to a bottom surface of the bed portion, wherein an upper portion includes two spaced and opposed end members hingedly attached to a center member.

In accordance with one aspect of the first embodiment, the actuation member includes a solenoid member.

In accordance with one aspect of the first embodiment, the actuation member includes a gear motor member.

In accordance with a second embodiment of the present invention, a tonneau cover assembly for a vehicle is provided, wherein the vehicle includes a passenger compartment, an open bed portion and a tailgate portion, comprising:
a first beam member attached to an upper surface of the bed portion proximate to the passenger cabin;
a second beam attached to a spaced and opposed upper surface of the bed portion proximate to the tailgate portion;
wherein the first and second beam members include an area defining a track formed therein;
wherein the first and second beam members include an area defining an aperture formed in a surface thereof;
a first door assembly operable to cover at least a portion of the open bed portion;
wherein the first door assembly includes first and second door members;
wherein the first and second door members are hingedly interconnected so as to be operable to rotate about one another;
wherein at least one of the first and second door members includes a pin member received within a pinion member;
wherein the pinion member is operable to be received within the tracks of the first and second beam members and rotate on a toothed rack within the track;
wherein the pin member is operable to be received within and retracted from the apertures of the first and second beam members; and
an actuation member operably associated with the pin member;
wherein when the actuation member is in a first mode of operation, the pin member is received within the apertures of the first and second beam members so as to prevent the first and second door members from rotating about one another;
wherein when the actuation member is in a second mode of operation, the pin member is retracted from the apertures of the first and second beam members so as to allow the first and second door members to rotate about one another.

In accordance with one aspect of the second embodiment, the tonneau cover assembly for a vehicle further comprises:
a third beam member attached to a left upper surface of the bed portion; and
a fourth beam member attached to a right upper surface of the bed portion.

In accordance with one aspect of the second embodiment, the tonneau cover assembly for a vehicle further comprises:
a second door assembly operable to cover a second portion of the open bed portion;
wherein the second door assembly includes third and fourth door members;
wherein the third and fourth door members of the second door assembly are hingedly interconnected so as to be operable to rotate about one another;
wherein at least one of the third and fourth door members of the second door assembly includes a pin member received within a pinion member;
wherein the pinion member is operable to be received within the tracks of the first and second beam members and rotate on a toothed rack within the track;
wherein the pin member is operable to be received within and retracted from the apertures of the first and second beam members; and
a second actuation member operably associated with the pin member;
wherein when the second actuation member is in a first mode of operation, the pin member is received within the apertures of the first and second beam members so as to prevent the third and fourth door members of the second door assembly from rotating about one another;
wherein when the second actuation member is in a second mode of operation, the pin member is retracted from the apertures of the first and second beam members so as to allow the third and fourth door members of the second door assembly to rotate about one another.

In accordance with one aspect of the second embodiment, the first and second door members of the first door assembly or the third and fourth door members of the second door assembly are operable to be rotated about one another so as to be positioned towards the left or right portion of the bed portion.

In accordance with one aspect of the second embodiment, the first and second door members of the first door assembly or the third and fourth door members of the second door assembly are operable to be rotated about one another so as to be positioned towards a centerline of the bed portion.

In accordance with one aspect of the second embodiment, the second beam member is hingedly attached to the upper surface of the bed portion proximate to the tailgate portion.

In accordance with one aspect of the second embodiment, the tonneau cover assembly for a vehicle further comprises a center support member, wherein a lower portion is fastened to a bottom surface of the bed portion, wherein two spaced and opposed end members of the second beam member are hingedly attached to a center portion of the center support member.

In accordance with one aspect of the second embodiment, the actuation member includes a solenoid member.

In accordance with one aspect of the second embodiment, the actuation member includes a gear motor member.

In accordance with a third embodiment of the present invention, a tonneau cover assembly for a vehicle is provided, wherein the vehicle includes a passenger compartment, an open bed portion and a tailgate portion, comprising:
a first beam member attached to an upper surface of the bed portion proximate to the passenger cabin;
a second beam attached to a spaced and opposed upper surface of the bed portion proximate to the tailgate portion;
a third beam member attached to a left upper surface of the bed portion;
a fourth beam member attached to a spaced and opposed right upper surface of the bed portion;
wherein the first and second beam members include an area defining a track formed therein;
wherein the first and second beam members include an area defining an aperture formed in a surface thereof;
a first door assembly operable to cover a first portion of the open bed portion;
wherein the first door assembly includes first and second door members;
wherein the first and second door members are hingedly interconnected so as to be operable to rotate about one another;
wherein at least one of the first and second door members includes a pin member received within a pinion member;
wherein the pinion member is operable to be received within the tracks of the first and second beam members and rotate on a toothed rack within the track;
wherein the pin member is operable to be received within and retracted from the apertures of the first and second beam members; and
‘a first actuation member operably associated with the pin member;
wherein when the first actuation member is in a first mode of operation, the pin member is received within the apertures of the first and second beam members so as to prevent the two door members from rotating about one another;
wherein when the first actuation member is in a second mode of operation, the pin member is retracted from the apertures of the first and second beam members so as to allow the first and second door members to rotate about one another;
a second door assembly operable to cover a second portion of the open bed portion;
wherein the second door assembly includes third and fourth door members;
wherein the third and fourth door members of the second door assembly are hingedly interconnected so as to be operable to rotate about one another;
wherein at least one of the third and fourth door members of the second door assembly includes a pin member received within a pinion member;
wherein the pinion member of the third or fourth door members is operable to be received within the tracks of the first and second beam members and rotate on a toothed rack within the track;
wherein the pin member of the third or fourth door members is operable to be received within and retracted from the apertures of the first and second beam members; and
a second actuation member operably associated with the pin member of the third or fourth door members;
wherein when the second actuation member is in a first mode of operation, the pin member of the third or fourth door members is received within the apertures of the first and second beam members so as to prevent the third and fourth door members of the second door assembly from rotating about one another;
wherein when the second actuation member is in a second mode of operation, the pin member of the third and fourth door members is retracted from the apertures of the first and second beam members so as to allow the third and fourth door members of the second door assembly to rotate about one another.

In accordance with one aspect of the third embodiment, the first and second door members of the first door assembly or the third and fourth door members of the second door assembly are operable to be rotated about one another so as to be positioned towards the left or right portion of the bed portion.

In accordance with one aspect of the third embodiment, the first and second door members of the first door assembly or the third and fourth door members of the second door assembly are operable to be rotated about one another so as to be positioned towards a centerline of the bed portion.

In accordance with one aspect of the third embodiment, the second beam member is hingedly attached to the upper surface of the bed portion proximate to the tailgate portion.

In accordance with one aspect of the third embodiment, the tonneau cover assembly for a vehicle further comprises a center support member, wherein a lower portion is fastened to a bottom surface of the bed portion, wherein two spaced and opposed end members of the second beam member are hingedly attached to a center portion of the center support member.

In accordance with one aspect of the third embodiment, the first or second actuation member includes a solenoid member.

In accordance with one aspect of the third embodiment, the first or second actuation member includes a gear motor member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a schematic view of a pickup truck 1, wherein the bed is covered with a tonneau cover 2, having two longitudinal doors, each having two sections, the right door having sections 3a and 3b, the left door having sections 4a and 4b, as well as a tailgate 5, in accordance with the general teachings of the present invention.

FIG. 2A illustrates a schematic view of the pickup truck 1 shown in FIG. 1, with exposed bed 8, wherein the right door having sections 3a and 3b is folded and secured to the right, and wherein the left door having sections 4a and 4b is folded and secured to the left, in accordance with the general teachings of the present invention.

FIG. 2B illustrates a schematic view of the pickup truck 1 shown in FIG. 1, wherein the right door is folded to the center, exposing the bed 8, while the left door remains flat, in accordance with the general teachings of the present invention.

FIG. 2C illustrates Detail A shown in FIG. 2B, in accordance with the general teachings of the present invention.

FIG. 3A illustrates a schematic view of the pickup truck 1 shown in FIG. 1, wherein the bed 8 is formed by a front wall 9 having a top surface 12, a right wall 10 having a top surface 13, a left wall 11 having a top surface 14 and a tailgate 5 having a top surface 15, in accordance with the general teachings of the present invention.

FIG. 3B illustrates a schematic view of the pickup truck 1 shown in FIG. 1, wherein four beam assemblies 16, 17, 18 and 19 are attached to the pickup truck bed's walls as follows: front beam assembly 16 is permanently attached to front wall top surface 12, right beam assembly 17 is permanently attached to right wall top surface 13, left beam assembly 18 is permanently attached to left wall top surface 14, and tailgate beam assembly 19 (having three sections, i.e., a center section 20, a right section 21, and a left section 22) may be removably attached to the top surface 15 of the tailgate 5, in accordance with the general teachings of the present invention.

FIG. 4A illustrates an elevational view of the right beam assembly 17, in accordance with the general teachings of the present invention.

FIG. 4B illustrates an elevational view of the left beam assembly 18, in accordance with the general teachings of the present invention.

FIG. 4C illustrates a perspective view of the right beam assembly 17, in accordance with the general teachings of the present invention.

FIG. 4D illustrates a perspective view of the left beam assembly 18, in accordance with the general teachings of the present invention.

FIG. 4E illustrates a sectional view taken along line A-A of FIG. 4B, in accordance with the general teachings of the present invention.

FIG. 4F illustrates a sectional view taken along line B-B of FIG. 4A, in accordance with the general teachings of the present invention.

FIG. 4G illustrates a partial elevational view showing the positions of a right rear pinion 74 and a left rear pinion 76 relative to a right door's right section 3a and a right door's left section 3b, respectively, of the right beam assembly 17, in accordance with the general teachings of the present invention.

FIG. 5A illustrates an elevational view (e.g., from the tailgate) of the front beam assembly 16, in accordance with the general teachings of the present invention.

FIG. 5B illustrates a sectional view of the front beam assembly 16, in accordance with the general teachings of the present invention.

FIG. 5C illustrates a top view of the front beam assembly 16, in accordance with the general teachings of the present invention.

FIG. 5D illustrates a sectional view taken along line C-C of FIG. 5C showing details of the indicator spring 46, in accordance with the general teachings of the present invention.

FIG. 5E illustrates a sectional view taken along line D-D of FIG. 5C showing details of the locking pin indicator 44, in accordance with the general teachings of the present invention.

FIG. 5F illustrates a perspective view of a rack 42, in accordance with the general teachings of the present invention.

FIG. 6A illustrates a fragmentary elevational view of a tailgate beam 19, in accordance with the general teachings of the present invention.

FIG. 6B illustrates a perspective view of the tailgate beam 19, in accordance with the general teachings of the present invention.

FIG. 6C illustrates Detail B shown in FIG. 6B, in accordance with the general teachings of the present invention.

FIG. 6D illustrates a partial sectional view showing details of the pin lock indicator assembly 44, in accordance with the general teachings of the present invention.

FIG. 6E illustrates a partial sectional view showing details of the locking pin 49, in accordance with the general teachings of the present invention.

FIG. 6F illustrates a perspective view of a right rear pinion 74 operably associated with the rack 42, in accordance with the general teachings of the present invention.

FIG. 6G illustrates a schematic view of the pickup truck 1 with a rotatable section 20 of the tailgate beam assembly 19 in the lowered position, in accordance with the general teachings of the present invention.

FIG. 6H illustrates a schematic view of the pickup truck 1 with a rotatable section 20 of the tailgate beam assembly 19 in the partially raised position, in accordance with the general teachings of the present invention.

FIG. 6I illustrates a detail view of the rotatable section 20 of the tailgate beam assembly 19 in the lowered position, in accordance with the general teachings of the present invention.

FIG. 6J illustrates a detail view of the rotatable section 20 of the tailgate beam assembly 19 in the partially raised position, in accordance with the general teachings of the present invention.

FIG. 6K illustrates a perspective view of a locking assembly for securing the rotatable section 20 of the tailgate beam assembly 19 when in the lowered position, in accordance with the general teachings of the present invention.

FIG. 6L illustrates a perspective view of a T-beam assembly 66, in accordance with the general teachings of the present invention.

FIG. 6M illustrates a schematic view of the pickup truck 1 with the T-beam assembly 66 installed therein, in accordance with the general teachings of the present invention.

FIG. 6N illustrates a detail view of a leg assembly 71 of the T-beam assembly 66 installed on the bed 8 of the pickup truck 1, in accordance with the general teachings of the present invention.

FIG. 6O illustrates a detail view of the pin lock indicator assembly 44 of the T-beam assembly 66, in accordance with the general teachings of the present invention.

FIG. 7A illustrates a top view of a first embodiment of a right door assembly, in accordance with the general teachings of the present invention.

FIG. 7B illustrates a partial sectional view of the first embodiment of the right door assembly, in accordance with the general teachings of the present invention.

FIG. 7C illustrates a fragmentary sectional view of the first embodiment of the right door assembly including the hinge 125, in accordance with the general teachings of the present invention.

FIG. 7D illustrates a top view of a first embodiment of the right door assembly in a ready to fold to the center position, in accordance with the general teachings of the present invention.

FIG. 7E illustrates a top view of a first embodiment of the right door assembly in a ready to fold to the side folding position, in accordance with the general teachings of the present invention.

FIG. 7F illustrates a top view of a first embodiment of the right door assembly in a flat or neutral position, in accordance with the general teachings of the present invention.

FIG. 7G illustrates Detail C shown in FIG. 7D, in accordance with the general teachings of the present invention.

FIG. 7H illustrates Detail D shown in FIG. 7E, in accordance with the general teachings of the present invention.

FIG. 7I illustrates a partial sectional view of a door assembly having a pin retracting mechanism in a folded configuration, in accordance with the general teachings of the present invention.

FIG. 7J illustrates a partial sectional view of a door assembly having a pin retracting mechanism, in accordance with the general teachings of the present invention.

FIG. 7K illustrates an elevational view of a door assembly having a pin retracting mechanism with an alternative top seal 129, in accordance with the general teachings of the present invention.

FIG. 7L illustrates an exploded view of a door assembly having a pin retracting mechanism, in accordance with the general teachings of the present invention.

FIG. 7M illustrates a top perspective view of a control handle, in accordance with the general teachings of the present invention.

FIG. 7N illustrates a bottom perspective view of the control handle shown in FIG. 7M, in accordance with the general teachings of the present invention.

FIG. 7O illustrates a top view of the control handle shown in FIG. 7M, in accordance with the general teachings of the present invention.

FIG. 7P illustrates a sectional view taken along line E-E of FIG. 7O, in accordance with the general teachings of the present invention.

FIG. 7Q illustrates a sectional view of the control handle, in accordance with the general teachings of the present invention.

FIG. 8A illustrates a top view of a second embodiment of a right door assembly, in accordance with the general teachings of the present invention.

FIG. 8B illustrates a perspective view of a control handle of the second embodiment of the right door assembly shown in FIG. 8A, in accordance with the general teachings of the present invention.

FIG. 8C illustrates a partial perspective view of a solenoid actuator for activating locking pins of the second embodiment of the right door assembly shown in FIG. 8A, in accordance with the general teachings of the present invention.

FIG. 9A illustrates a top view of a third embodiment of a right door assembly, showing the door with the center pins locked and a gear motor ready to fold the door to the center, in accordance with the general teachings of the present invention.

FIG. 9B illustrates Detail E shown in FIG. 9A, in accordance with the general teachings of the present invention.

FIG. 9C illustrates a perspective view of a gear motor of the third embodiment of the right door assembly shown in FIG. 9A, in accordance with the general teachings of the present invention.

FIG. 9D illustrates Detail F shown in FIG. 9C, in accordance with the general teachings of the present invention.

FIG. 9E illustrates a perspective view of a right swiveling arm of the third embodiment of the right door assembly shown in FIG. 9A, in accordance with the general teachings of the present invention.

FIG. 10A illustrates a flow chart of the primary steps of the third embodiment functions regarding a right door center folding action, in accordance with the general teachings of the present invention.

FIG. 10B illustrates a flow chart of the primary steps of the third embodiment functions regarding a right door flattening action from a center fold, in accordance with the general teachings of the present invention.

FIG. 10C illustrates a schematic view of the relative element positions of the third embodiment, in accordance with the general teachings of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

All directions referenced herein, i.e., left or right, are stated based on the observer viewing the TC from the rear of the truck/tailgate towards the truck's front, i.e., the passenger cabin.

The various descriptions below will focus on the right door assemblies and functionalities. The left door is a mirror design of the right door and carries the same functions.

### 1^{st} Embodiment-Manual Operation

This embodiment describes an all-mechanically operated tonneau cover.

The first embodiment describes a tonneau cover (TC) comprised of two foldable doors, each having two sections, situated longitudinally over the truck's bed and secured within four beam assemblies that are secured over the bed's front and side walls top surfaces and over the tailgate top surface.

Although the following description will primarily be directed to use of the present invention in conjunction with a pickup truck, it should be appreciated that the present invention can also be practiced with any type of vehicle, including motor vehicles that include an open space that needs to be covered and/or secured.

Furthermore, it should be appreciated that the present invention can also be practiced with any type of non-motorized vehicle, such as, but not limited to, pull carts, push carts, and/or the like, that include an open space that needs to be covered and/or secured.

The doors can be folded and secured either over their respective sidewalls or at the center area of the bed. These capabilities allow access to the box's content and even carrying irregular size objects while still retaining the TC on the truck and, at the same time, providing good visibility rearwards to the driver.

Folding and re-flattening of the TC door may be done via a manually operated control handle situated at the rear portion of the TC.

Rotating the handle to either side causes the recession of a respective pair locking pins outside their respective locking holes, for as long as the handle is kept in its rotated position, thus allowing the folding or re-flattening of the door. This may be accomplished via cables that are pulled by the rotating handle and cause a swiveling movement on arms that force the retreat of the locking pins while still allowing rotation of the rigid hollow shaft and pinions. When the folding or re-flattening of the door is completed, the release of the handle allows the compression-spring between the locking pins to force the return of the locking pins into their respective holes, thus securing the door in its selected position.

The folding and re-flattening of the door may be being assisted by four pinions at each corner of the door. As an example, the right edge of the right section of the right door contains a rotatable, hollow rigid shaft assembly with two pinions attached rigidly to its ends. The pinions are placed within areas defining recesses, slots, tracks or voids formed in the front and tailgate beams, each containing a toothed rack. Thus, folding or re-flattening a door forces the coordinated rolling of the shaft and pinions on the racks, providing a synchronized straight folding or re-flattening movements while eliminating skewing.

The doors are each being secured by four spring-loaded locking pins, movable within the hollow pinion-carrying shafts. Once reaching the desired position, i.e., the door is flattened, side or center-folded, the pins are spring-pushed into their respective locking holes, thus securing the door in its selected position.

Once the locking pins reside within its respective locking hole, visible indicators are pushed by the locking pin to inform the operator that the respective locking pin is in its locked position.

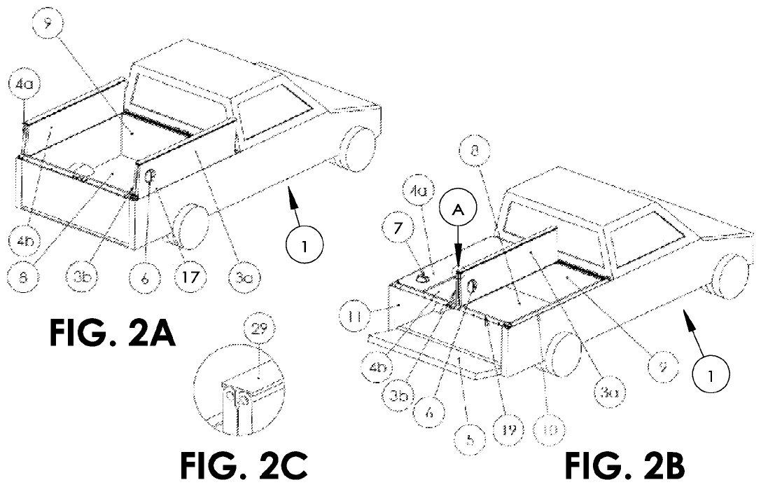

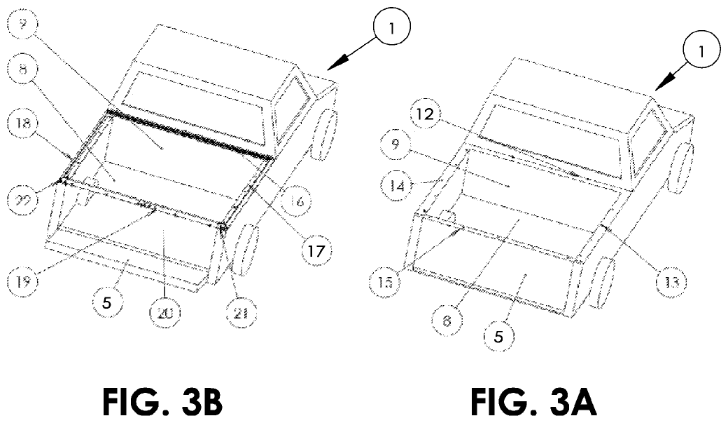

Referring to the Figures generally, and specifically to FIGS. 2-3B, there is shown a schematic view of a typical pickup truck 1 having a bed 8. The bed 8 is covered by a four-section tonneau cover (TC) 2. The TC 2 may be constructed of two doors: a right door 3 and a left door 4, each door having two sections. The doors meet along the box's longitudinal center.

The right door 3 includes right section 3a and left section 3b while the left door 4 includes right section 4b and left section 4a. The doors 3, 4, respectively, may be folded to the side or the center of the bed 8, thus providing exceptional utility without the need to remove the TC 2.

Although the following description will focus primarily on the right door 3, comprised of sections 3a and 3b, it should be appreciated that the left door 4, comprised of sections 4a and 4b, is essentially mirror-symmetrical in all aspects to the right door 3.

The right door 3 includes a handle assembly 6 (the left door 4 includes a handle assembly 7), and is preferably situated in close proximity to right side, at the rear of the bed 8, for example, for ease of reach.

The right door 3 may be held in various positions, i.e., flat, center-folded and/or side folded, by a framework of beams (e.g., see FIGS. 3A-3B). For example, front beam assembly 16 may be permanently attached to a front wall 9 right top surface 12, right beam assembly 17 may be permanently attached to right wall 10 top surface 13, left beam assembly 18 may be permanently attached to left wall 11 top surface 14, and removable tailgate beam assembly 19, having three sections: right section 21, left section 22 and a rotatable section 20, may be removably attached to the top surface 15 of the tailgate 5. Sections 21 and 22 may be firmly attached to the bed's proximal section of sidewall surfaces 13 and 14, respectively (e.g., see FIGS. 3A-3B).

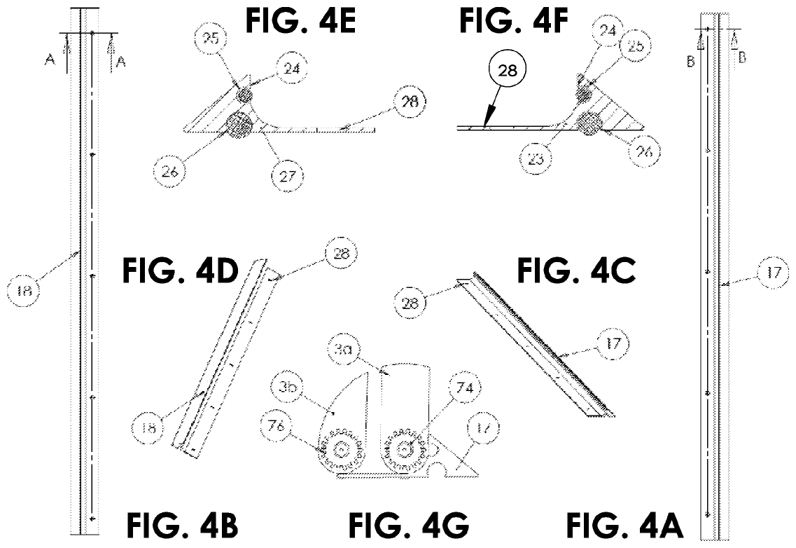

Referring to the Figures generally, and specifically to FIGS. 4A-4G, there is shown the right beam assembly 17 and the left beam assembly 18. These assemblies may be made of metal or plastic extrusions. Each beam having a body 23 (denoted as 27 in the left beam assembly 18), vertical wall 24 and at least one seal 25 on the wall and a bottom seal 26. Also shown are optional attachment holes 28. FIG. 4G shows the sections 3a and 3b held vertically against the right-side beam 17, as in a side folded position.

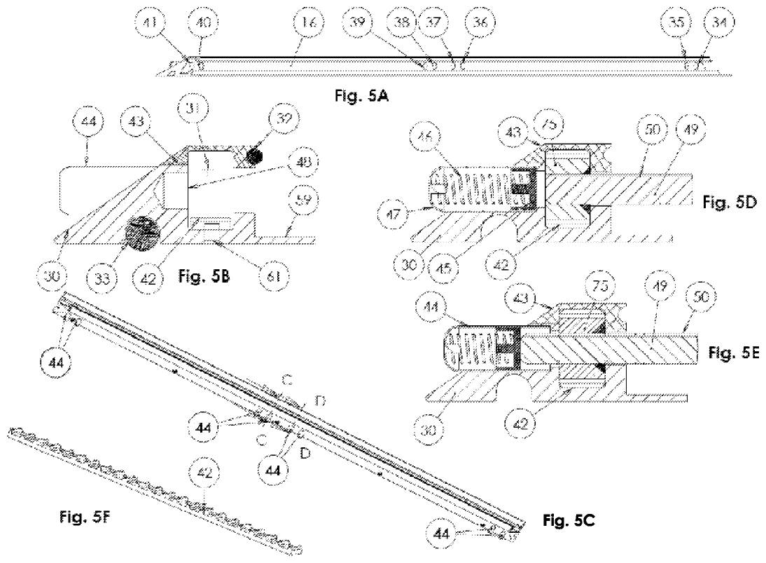

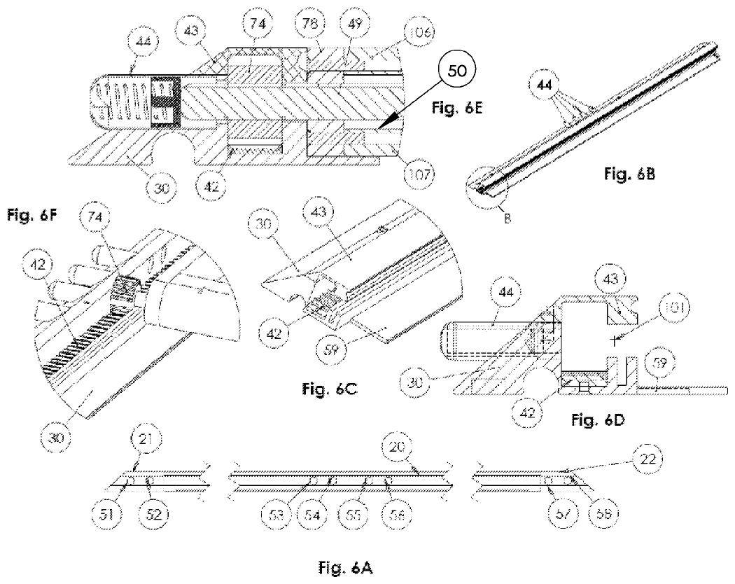

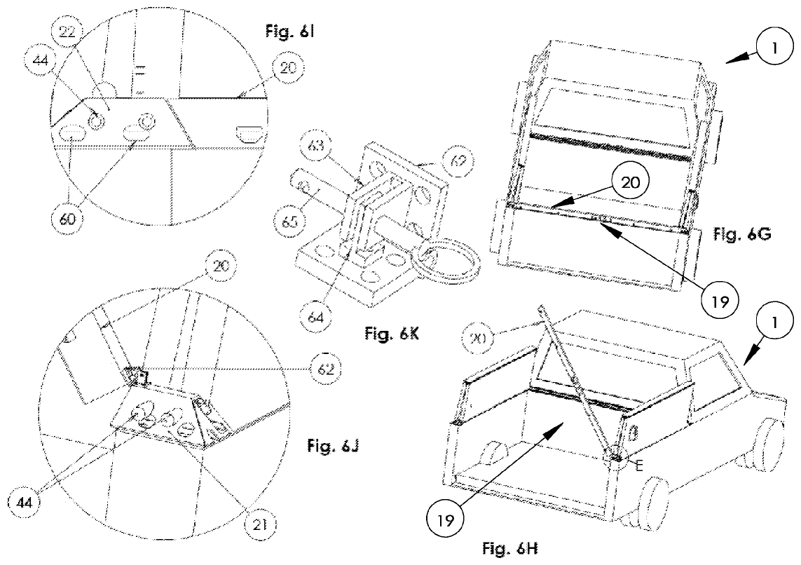

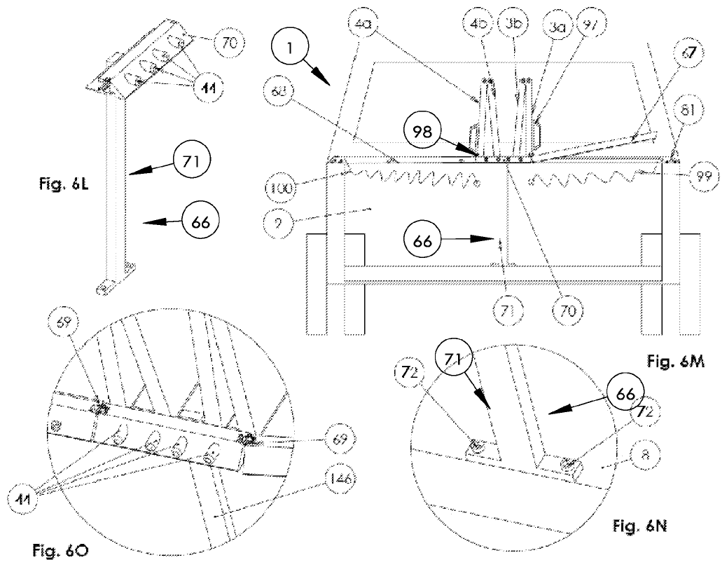

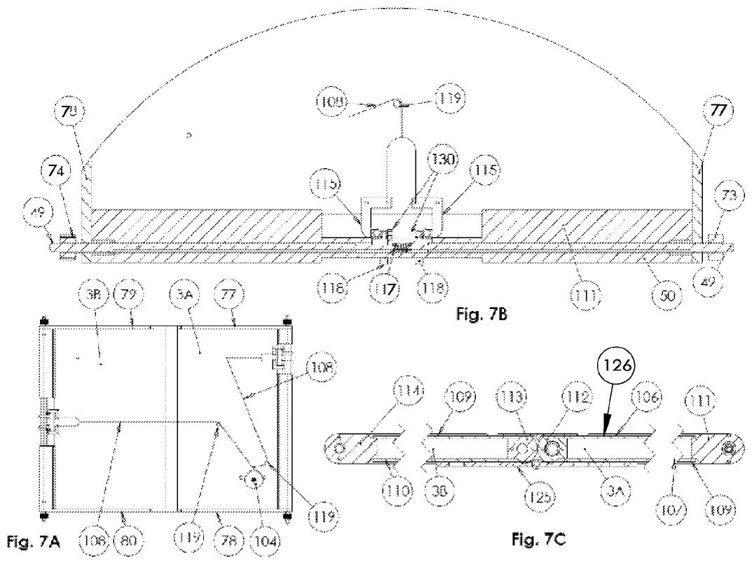

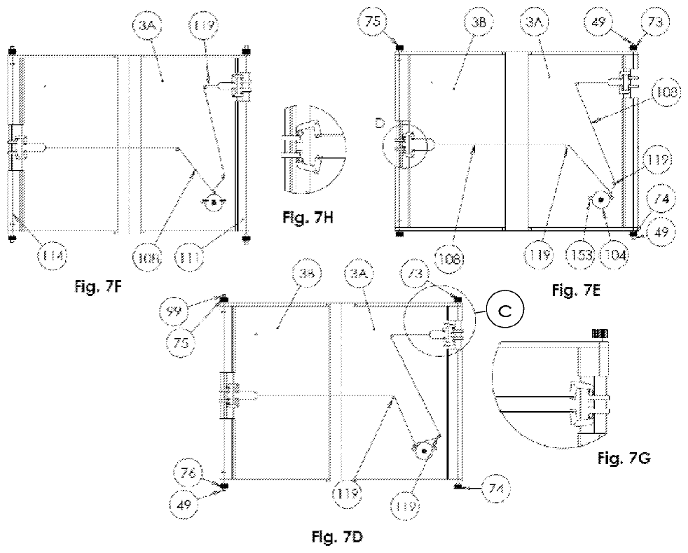

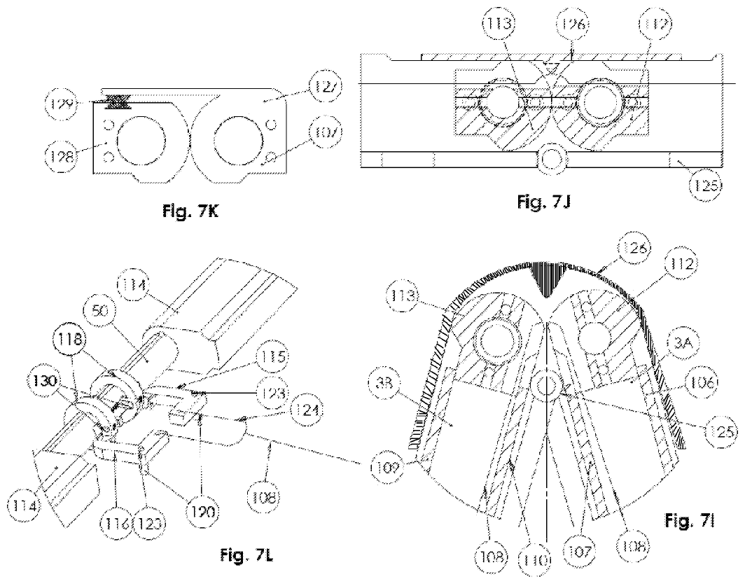

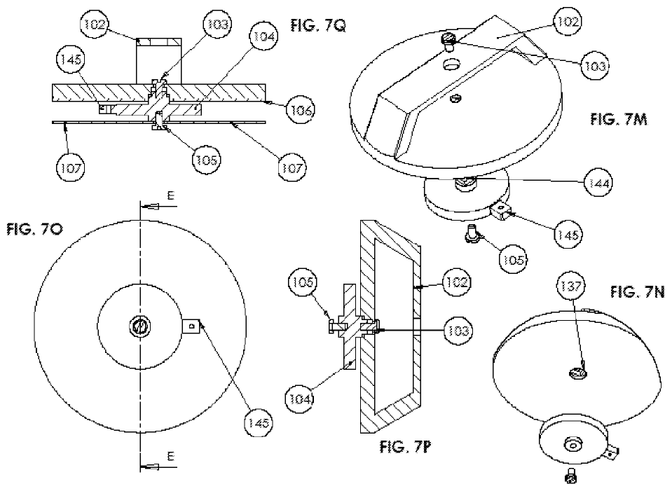

Referring to the Figures generally, and specifically to FIGS. 5A-7P, the front beam assembly 16 is shown. This beam may be constructed of two profiles permanently attached with fasteners (e.g., screws). The bottom profile 30 and upper profile 43 form a track 31 in which pinions 73 and 75 may roll over a rack 42. The pinions 73 and 75 may be placed in the front corners of the right door (e.g., see FIGS. 7A-7P). The gear rack 42 attached to the bottom profile 30 with screws 61 (e.g., see FIGS. 5A-5E and 7A-7P). The tailgate beam 19 houses pinions 74 and 76 in the same fashion (e.g., see FIGS. 6A-6O). Top seal 32 and bottom seal 33 are also provided.

Holes 34, 35, 36, 37, 38, 39, 40 and 41 are placed to accommodate the locking pins 49 within the shafts 50 and their respective pinions 73 and 75 in the flat or center or side folded positions. These holes' intended functions may be: hole 34 is the right door, front-right locking hole; hole 35 is the right door front side-folding locking hole; hole 36 is the right door front center-folding locking hole; hole 37 is the right door front center-locking hole; hole 38 is the left door, front right locking hole; hole 39 is the left door front center-folding locking hole; hole 40 Is the left door front side-folding locking hole; and hole 41 is the left door front left-locking hole.

Referring to the Figures generally, and specifically to FIGS. 5D-5E, there is shown the locking pin indicator 44 details (e.g., the attachment holes 61 and/or screws 60 are also shown). The indicator may be visibly installed as an extension to all locking holes on the front beam 16 and tailgate beam 19. The indicator may be comprised of a transparent lens 47 securely attached to the lower profile 30 (e.g., by adhesive or a thread). The lens 47 contains a compression spring 46 and a colored (e.g., bright green) slider 45. When the locking pin 49 is retracted away from its respective locking hole 34, the slider 45 may be invisible as it is pushed back by the spring 46. However, when the locking pin 49 re-enters its respective hole 48, as shown in FIG. 5E, it pushes the colored slider 45 deeper into the lens 47 where it may be visible to the TC operator, indicating that the pin that supposed to enter this hole is locked in place. This is a simple and reliable way to give the operator of the TC a visible assurance that the necessary pins may now securely lock the TC in its new position.

Referring to the Figures generally, and specifically to FIGS. 6A-6F, the tailgate beam assembly 19 includes the same holes and mirrors the locations and similar intended functions as the ones in the front beam assembly 16, as described above. These holes are numbered 51-58 as shown in FIG. 6A. The tailgate beam 19 has three sections. Sections 21 and 22 may be rigidly attached to the truck's proximal side walls' top surfaces. The center section 20 may be rotatable (e.g., see FIGS. 6G-6K). In all other aspects, the beam construction is identical to the front beam 16, i.e., the same lower profile 30 and top profile 43, with the same gear rack 42 and locking pins indicators 44.

FIG. 6E shows a partial section through the right door's section 3A having a rear wall 78, a top cover 106 and a bottom cover 107. Also shown is the partial sectional view of the rotatable shaft 50 (e.g., see FIGS. 5D-5E), which rotates in end wall 78, when section 3a is pulled/pushed to a new position, with its pinion 74 that rolls on rack 42. The right and left doors' sections may be supported by the tailgate and front profiles' flat portion 59, e.g., as shown in FIG. 6C. FIG. 6F shows a door section with its pinion resting on the rack 42, inside the lower profile 30. FIG. 6B shows an isometric view of the tailgate beam 19 center section 20.

Referring to the Figures generally, and specifically to FIGS. 6G-6K, the design of the tailgate beam assembly 19 with its three sections is intended to provide the maximal convenience and practicality to the operator of the TC. FIGS. 6G-6J shows the hinged and rotatable section 20. This section may be held flat by a magnetic latch (not shown) to form, when held flat, a continuous beam with sections 21 and 22. However, once the doors are folded to the sides, section 20 may be detached from section 22 and rotated to the right (a preferred example for markets with right side driving) thus allowing unobstructed loading and unloading of the truck's bed. Section 20 may be secured temporarily to the folded right panel by the latch and hinge design 62 (including any of a locking fork 63, locking bracket 64 and/or locking pin plunger 65) or Velcro straps, magnetic latch or other common arrangements (not shown), as shown in FIG. 6K.

Referring to the Figures generally, and specifically to FIGS. 6L-6O, there is shown an alternative tailgate beam assembly 66, where a right section 67 and a left section 68 may be detached from its respective fixed section 81 or 82 and rotated vertically on hinge 69 to ease access to the bed once the right or left door is folded to the center. This tailgate beam design may be comprised of a leg assembly 71 fastened to the bed's floor by fasteners 72 (e.g., screws) or other attachment methods, like Velcro or magnets to avoid drilling holes in the bed's floor (not shown). The leg assembly may be comprised of a bottom leg beam carrying a center section 70, to which the right beam 67 and left beam 68 may be attached via hinges 69. Naturally, all sections include the same profiles, racks and indicators assemblies as in the tailgate beam assembly 19 that was detailed above, e.g., as shown in FIGS. 6A-6J. Also shown are right control handle 97 and left control handle 98.

Referring to the Figures generally, and specifically to FIGS. 7A-7C, there is shown the right door with its sections 3a and 3b where the top covers 106 and 109 and the handgrip 102 were removed to enable viewing the inside portions of the sections. Shown as well are a cross-section of the right profile 111, and a top view of the locking pin retracting mechanism. A typical cross section of the right door is shown as well.

The right door may be comprised of four profiles: the right section 3a right profile 11, the right section left profile 112, the left section 3b right profile 113 and the left section left profile 114. The profiles connect rigidly to front walls 77 and 79 and rear walls 78 and 80. The profiles and walls may be made of metal or plastic. They may be connected via fasteners (e.g., screws, not shown). Each section may be covered by top and bottom covers. The right section may be covered by top cover 106 and bottom cover 107. The left section may be covered with top cover 109 and bottom cover 110. The covers may be permanently connected to the profiles by either adhesive or fasteners such as screws or rivets (not shown). The folding movement of the sections 3a and 3b may be enabled by hinges 125, connecting the sections at the bottom surfaces and allowing the folding and re-flattening movements of the door's section 3a and 3n. The sections may be sealed from the top, when in flat position, with an elastic seal 126, as shown in FIGS. 71-7J.

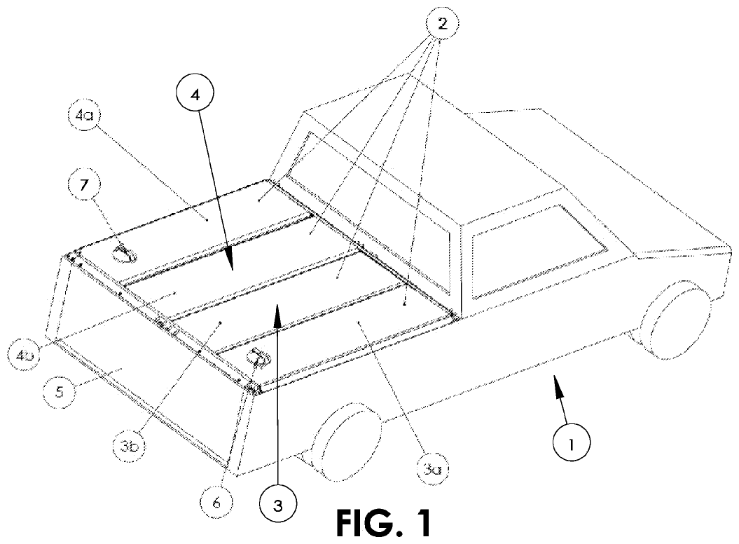

Each of the side profiles of the right door, i.e., the right profile 111 and the left profile 114 may contain a rotating hollow shaft 50 and a pair of locking pins' 49 assembly as shown in FIG. 7B and in FIGS. 5A-5E and FIGS. 6A-6E. As an example, the shaft 50 may be mounted through the hollow part of profile 111 and secured but free to rotate in dedicated holes in the front wall 77 and rear wall 78 (a bearing may be used, but is not shown). The shaft 50 may rotate freely within these holes. Hollow shaft 50 may carry two long locking pins 49 inside it, as shown, that may be free to slide fore and aft and may normally be pushed apart by the pins-extending compression spring 117 as shown. The same shaft may carry two rigidly attached (shown welded here but not limited to being welded) pinions 73 and 74 as shown. These pinions may be forced to roll on racks that may be placed within the front beam 16 and tailgate beam 19 when the handle 6 (e.g., see, see FIGS. 1A-2C), is being pulled or pushed after being rotated to allow side or center-folding or re-flattening as will be explained below.

The control handle is shown in detail in FIGS. 7M-7P. It comprises a hand grip 102 that may be connected to a cable arm 104 via a top screw 103. The cable arm 104 may be comprised of a disk with a cable connecting tab 145 with a hole for cables attachment as shown. The cable arm may have two central bosses. The top one may have a square section 144 that fits into a square recess 137 in the handgrip 102 bottom portion such that it forces both the handgrip 102 and cable arm 104 to rotate together. The threads in the two bosses may be designed such as by tightening the top screw 103 and bottom screw 105, the handle assembly can rotate freely and securely between the right section 3a top cover 106 and bottom cover 107. The change of position of the door, i.e., folding sideway or to the center or re-flattening requires the retraction of the respective pair of locking pins that secures the door's position. This may be initiated by rotating the handle with its cable arm 104 either left or right until stopped by a stop rivet 153. As an example, in order to center-fold the right door (e.g., see FIGS. 7D-7F), the pins within pinions 73 and 74 must be retracted from their respective locking holes 34 (e.g., see FIGS. 5A-5F) and 51 (see FIGS. 6A-6F). The handle may be rotated counterclockwise (CCW), causing the pull of the cable 108 coming from the right profile retracting mechanism. The retraction may be performed by two swiveling arms 115 and 116 (e.g. see FIGS. 7B, 7G and 7L). The arms may be made to swivel over bosses 120 and may be secured by fasteners 123 (e.g., screws). The arms may be connected to a cable assembly 108 which in turn may be connected to the cable arm 104, rigidly attached to handle 6 handgrip 102, in a pattern as dictated by the cable guiding rivets 119 (e.g., as shown in FIG. 7A-7F). When the arms 115 and 116 are pulled by their respective cable assembly 108, they may be forced to swivel towards each other. Each arm may carry a roller 121 that may be free to rotate on its axle 122. The arms, through their rollers 121 may push the rings 118 that may be rigidly attached to the locking pins 49 arms 130, forcing the retreat of the pins 49 from their respective holes in front beam 16 and tailgate beam 19, while at the same time allowing the rotation of the hollow shaft 50 that is caused by its pinions to be forced to roll on racks 42 during a folding or re-flattening movement. This specific feature provides retraction of the locking pins while their respective shaft is rolling and moving linearly at the same time within the guiding tracks in the front and tailgate beams and where the pinions and racks inherently deliver mechanically synchronized movement of the folding sections.

FIGS. 7D-7F shows three top views of the right door, where the top covers 106 and 109 and hand-grip 102 were removed for clarity. Shown are the cable arm 104, the cables 108, the swiveling arms 115 and 116 and locking pins details in all three possible positions of the cable arm, namely neutral position (FIG. 7F), side folding (FIG. 7E) and center folding (FIG. 7D). Note, the locking pins retracting mechanisms are shown larger for clarity. Actual size may be smaller to allow containment within the respective profile.

In the neutral position, all pins may be extended and the swiveling arms may be in their neutral position.

In the center folding position, the handle grip 102 may be rotated counter-clockwise, pulling the cable that comes from the right swiveling arms mechanism as shown, thus forcing them to converge towards each other and thus forcing rings 118 that may be attached to the locking pins' arms 130 to move towards the shaft 50 center and retract the locking pins within pinions 73 and 74. At this point, the operator may lift and push the handgrip 102 and force the folding of the right door to the center. Once the center fold is reached, the operator releases the handgrip, thus allowing compression spring 117 to force the sliding of the locking pins into their center-folding locking holes. Re-flattening of the right door from the center-folded position requires the same counter clockwise rotation of the handle, resulting of the retreat of locking pins 49 within pinions 73 and 74 and pull back of the folded door into a flat position. Release of the handle will allow the locking pins to lock in their respective flat position holes, 34 and 51, thus securing the TC.

Similar processes apply to the side folding, where a clockwise rotation of the handle results in the retreat of the locking pins within the shaft 50 in the left profile 114. The pull and fold of sections 3a and 3b to the right-side wall, and re-locking of the pins within pinions 75 and 76 in their side-locking holes 35 and 52, secure the folded right door in its side folded position.

Naturally, the same principles apply for re-flattening the right door to its flat position or executing the same operations on the left door.

FIGS. 71-7K show a 3-D view of the pin retracting mechanism as described above. FIG. 7I shows the sections 3a and 3b partially folded, with the top elastic seal 126 and bottom hinge 125 and the cable 108 routed through slots in the center profiles 112 and 113. FIG. 7K shows an alternative top seal design where new center profiles 127 and 128 replace elements 112 and 113, where the integral arm of profile 127 presses a new top seal 129 held by the left profile 128. Also shown is a cable fork 124.

### Second Embodiment: Manual Folding and Flattening with Solenoid-Activated Locking Pins

Here and in the rest of the detailed description below, it should be noted that detailed electrical circuit diagrams and drawings are not depicted as this subject matter is considered to be of common knowledge to one of ordinary skill in the art.

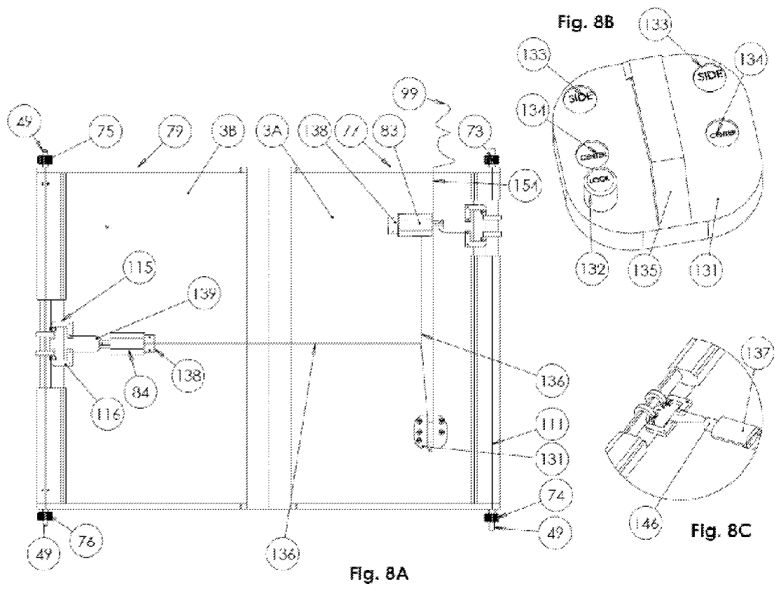

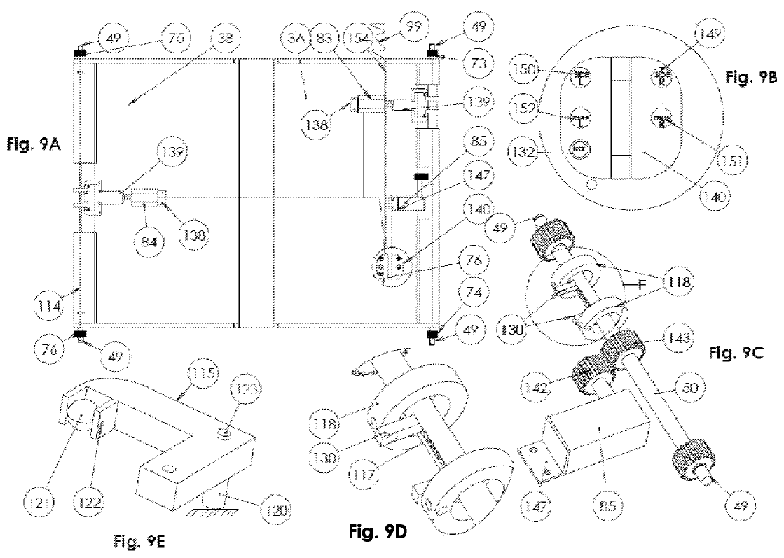

The 2^{nd} embodiment, shown in FIGS. 8A-8C, is mostly identical to the first embodiment described above; however, some of the primary differences include: (1) solenoid-actuator actuated pins retraction mechanisms replace the cables retraction of the locking pins; (2) control cables may be eliminated and replaced by electrical wires 136 connecting the new handle to the pertaining solenoid-actuators; (3) the handle has no rotational movements, only press buttons; (4) the handle-controlled circuitry may be powered by the pickup truck battery (flexible wiring 99 and 100 may be added to connect the truck's battery to the doors); and (5) the mechanical lock indicators 42 may be substituted by LEDs (not shown).

The rest of the door and beams' construction remain as in the 1^{st} embodiment above.

FIGS. 8A-8C illustrate the primary features of the 2^{nd} embodiment.

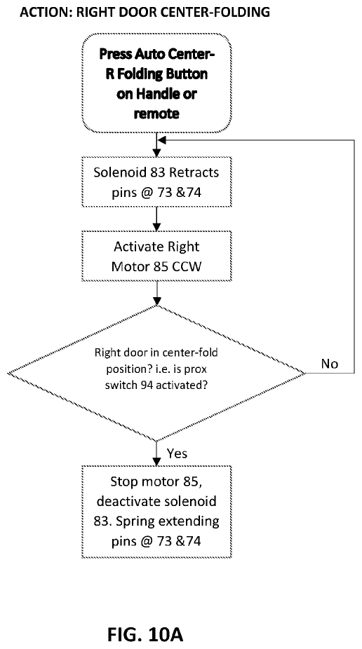

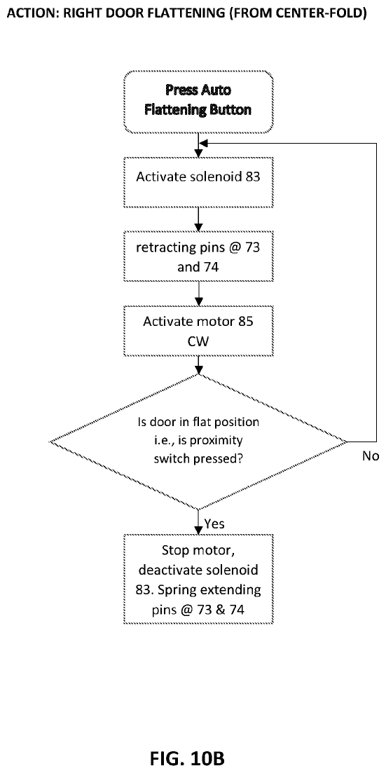

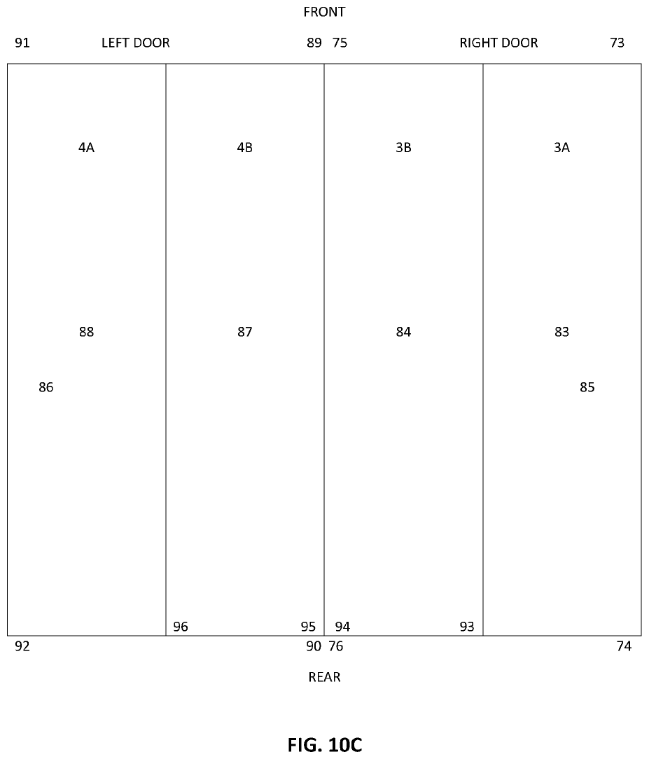

The handle 131, as specifically shown in FIG. 8B, may be used to grip (e.g., via hand grip 135) and fold or flatten the doors. It does not rotate. Instead, it may be equipped with push buttons marked as “SIDE” (133) and “CENTER” (134) as well as a lock button 132. The all-manual retraction of the locking pins may now be done by solenoid actuators. Pushing a specific button sends electric current to a (right door right) solenoid actuator 83 (element 84 denotes the right door left solenoid actuator, element 87 denotes the left door right solenoid actuator (e.g., see FIG. 10C), and element 88 denotes the left door left solenoid actuator (e.g., see FIG. 10C)) that may be mounted on bracket 138 typically attached to the section's bottom cover. This type of preferred solenoid actuator 83 (shown schematically) may be a “pull only,” meaning that once its internal coil is charged with DC current from the truck's battery (e.g., via power cable 154), it applies an electromagnetic pull on its core (not shown) that causes it to retreat deeper inside the solenoid actuator, depressing an internal compression spring (not shown). The protruding rod 146 may be firmly connected to the core (e.g., see also FIGS. 7A-7H and 9A-9E). A cable-loop 139 connects the solenoid-actuator rod 146 and to cable loop 139 that may be threaded through a hole in the rod 146. The cable loop may be tied to the pair of swiveling arm 115 and 116 which, when being pulled by cable loop 139, force the convergence of rings 118 that may be attached to the locking pins 49 arms 130 and hence the retreat of the respective locking pins from their respective holes, thus enabling the rolling of the shaft and pinions that contain the locking pins, with the pins being retracted. The release of the button de-energizes the solenoid actuator and the pins spring 117 pushes the locking pins 49 into their respective holes.

As an example, pushing and holding the “CENTER” marked button on the right door causes the passage of current to the respective (right) solenoid actuator 83 that may be mounted inside the right section 3a. Energizing the right solenoid causes the pull action of cables that may be connected to a pair of swiveling arms 115, 116. Pulling the arms causes the retreat of the respective pair of the locking pins 49, against the compression spring 117 that normally secures the pins in their respective holes. This allows the TC operator to lift/pull the handle followed by pushing the right door's right section towards the center. Releasing the CENTER button at this point de-energizes the right solenoid, allowing the pin-pulling arms to retreat while the compression spring 117 pushes the locking pins 49 and their rings 118 apart, forcing the pins into their holes, intended for a center-fold position of the right door, in this case holes 36 in the front beam and hole 53 in the tailgate beam. To re-flatten the right door, the operator presses the CENTER button again, which causes the retraction of the same locking pins 49, thus allowing the pull and flattening of the door, followed by the release of the CENTER button and the locking of the pins 49 into their flat position holes 34 and 51.

Side folding is similar. That is, the SIDE button may be pressed, energizing the left solenoid actuator that pulls the cable loop, forcing the left swiveling arms to push the respective rings together with the locking pins 49 arms and cause the retreat of the pair of locking pins 49 within pinions 75 and 76, i.e., holes 37 and 54. The operator pulls the handle towards the side, causing the right door to fold, by forcing the left rigid shaft within the left section's left profile to rotate with its two rigidly attached pinions rolling on the racks within the front and tailgate beams. Once a vertical position is reached, the operator releases the SIDE button and the pair of the left section's locking pins may enter the locking holes 35 and 52 for the side folding position.

### 3^{rd} Embodiment-Automatic Center Folding and Re-Flattening

The third embodiment as shown in FIGS. 9A-9E, includes all the features of the second embodiment with the following changes and additions: (1) The control handle 140 circuitry may be changed to include push buttons for automated center-folding and re-flattening of both doors; (2) two gear motor assemblies 141 may be contained within the right section 3a of the right door and section 4a of the left door, allowing powered, automated center-folding and/or re-flattening of the door; (3) the SIDE push buttons remain door-specific and it functions as in the 2^{nd} embodiment, i.e., retreating the respective pins with solenoid-actuators when pressed followed by manual side folding and/or re-flattening; and (4) a remote-control option may be added to allow remote fold/flatten of the doors.

The third embodiment calls for automated center folding and re-flattening of the doors, executed either by push buttons on the control handle 140 or via a remote control with proper circuitry within the handle's assembly (not shown).

This embodiment adds immense practicality to the TC 2 by allowing quick access to each of the longitudinal bed's volumes underneath each door. One can envision very efficient access to the bed's side portion contents, when parking the truck along a side-walk, thus increasing accessibility and safety of users.

Side-folding of the doors may be done as described in the 2^{nd} embodiment above, with a solenoid actuator retracting the pair of the respective locking pins followed by the operator manually pulling and folding the door to the side.

The automated folding to center and re-flattening of a door may be performed using a DC gear motor, which may be an electric motor combined with a reduction unit (e.g., a gear or gear assembly) that may be connected to an output pinion. These types of gear motors may be used to deliver low RPM with high torque. For the purpose of the invention herein, as shown in FIGS. 9A-9E, such a gear motor may be installed inside the door and placed such that its output pinion may be permanently engaged with a matching gear on the rotating shafts 50 that carry the two pinions on racks inside the front and tailgate beams. The details of center folding and re-flattening of the door are as follows.

A (right door) DC gear motor 85 (element 86 denotes the left door gear motor and is schematically shown in FIG. 10C), as shown in FIGS. 9A-9E may be installed with bracket 147 inside the right section 3A of the right door as shown. Here again, FIG. 9A is provided with the top covers removed for clarity. The gear motor 85 provides the driving force requires for center-folding and re-flattening of the right door. Obviously, a similar motor (not shown) with the same hardware may be installed inside section 4a of the left door. The gear motor 85 may carry a pinion gear 142 that may be permanently engaged with a matching gear 143 mounted rigidly on the rotating shaft 50.

It should be noted that the gear motor rotation direction may be stated as viewed by looking at the pinion's front with the gear motor behind it.

Following a depression of the CENTER-R button on the handle 140 or the same on a remote-control (not shown), the center-folding process (e.g., see the flow diagram in FIG. 10A), propagates. The solenoid actuator 83 retracts the locking pin pair in pinions 73 (located in the front beam) and 74 (located in the tailgate beam). This step may be followed by the gear motor's 85 pinion 142 rotating CCW (counter clockwise). This rotation causes the gear 143 that may be mounted permanently on the rotating shaft 50 to rotate clockwise (CW) thus causing its attached pinions 73 and 74 to travel to the left, i.e., towards the bed's center, on the racks 42 inside the front 16 and tailgate 19 beams. The rolling motion to the left causes the folding of section 3a and 3b. The rotation of the gear motor's pinion 142 may be stopped once the proximity (or limit) sensor 94 is activated, signaling that the right doors are in center-folding position. Once the center folding position is reached, both the gear motor 85 and the solenoid 83 may be deactivated, thus allowing the locking pins 49 inside pinions 73 and 74 to extend into their respective center-fold positions.

The re-flattening of the right door occurs following a remote control (not shown) signal or by depressing the CENTER-R button 151 again (e.g., see the flow diagram in FIG. 10B). The locking pins in pinions 73 and 74 may be retracted followed by the gear motor 85 rotating its pinion 142 to rotate clock wise (CW). This forces the rolling of the pinions 73 and 74 to the right, resulting in the flattening of sections 3a and 3b until the flat-position proximity sensor 93 is activated, causing the gear motor to stop, the deactivation of solenoid actuator 83 and hence, the spring-loaded locking pins extend into their respective flat position holes. Also provided are a SIDE-R button 149, a SIDE-L button 150 and a CENTER-L button 152.

It should be noted that the relative positions of the right front pinion (left door) 89, right rear pinion (left door) 90, left front pinion (left door) 91, left rear pinion (left door) 92, flat-position proximity sensor (left door) 95, and center-fold position proximity sensor (left door) 96 are depicted in FIG. 10C.

The folding of the doors to the sides may be done as described in the 2nd embodiment description above.

It is obvious that a fully automated version of the TC, namely powered center and side folding of both doors could be naturally derived from the principles of the present invention described herein.

Summarizing, the intended functions of the third embodiment are shown in the Table below:

TABLE

| | | Confirmation at |
|---|---|---|
| Function | Action | end |
| Folding right | Solenoid 83 activated | Pin indicators |
| door to center | Retracting pins @ 73, 74 | pertaining to |
| | Right gear motor 85 | 73 and 74 show |
| | rotates counter clockwise | green |
| | Center position limit switch | |
| | 94 reached | |
| | Motor off | |
| | Solenoid 83 off | |
| | Spring 117 extending pins | |
| | @ 73, 74 | |
| Flattening the | Solenoid 83 activated | Pins @ 73, 74 |
| right panel | Retracting pins @ 73, 74 | show green |
| | Right gear motor 85 | |
| | rotates clockwise | |
| | Flat position limit switch 93 | |
| | reached | |
| | motor 85 off | |
| | Solenoid 83 off | |
| | Spring 117 extending pins | |
| | @ 73, 74 | |
| Side-folding of | Same as in the 2nd | |
| the right panel | embodiment | |
| Re-flattening | Same as in the 2nd | |
| from side- | embodiment | |
| folding of the | | |
| right panel | | |

### FIGURE LEGEND LISTING

1. Pickup truck, 2. Bed tonneau cover, 3A. Right door's right section, 3B. Right door's left section, 4A. Left door's left section, 4B. Left door's right section, 5. Tailgate, 6. Manual handle right door, 7. Manual handle left door, 8. Truck's bed, 9. Bed's front wall, 10. Bed's right wall, 11. Bed's left wall, 12. Front wall top surface, 13. Right wall top surface, 14. Left wall top surface, 15. Tailgate top surface, 16. Front beam assembly, 17. Right beam assembly, 18. Left beam assembly, 19. Tailgate beam assembly, 20. Tailgate beam center section, 21. Tailgate beam right section, 22. Tailgate beam left section, 23. Right beam body, 24. Vertical wall, 25. Side seal, 26. Bottom seal, 27. Left beam body, 28. Attachment hole, 30. Front and tailgate beams lower profile, 31. Guidance track, 32. Front and tailgate beams top seal, 33. Bottom seal, 34. Right door right locking front hole, 35. Right door side-folding front locking hole, 36. Right door center-folding front locking hole, 37. Right door center locking front hole, 38. Left door center locking front hole, 39. Left door center-folding front locking hole, 40. Left door side-folding front locking hole, 41. Left door left locking front hole, 42. Rack, 43. Front and tailgate beams upper profile, 44. Pin lock indicator assembly, 45. Slider (green), 46. Indicator spring, 47. Indicator's lens, 48. Locking pin hole, 49. Locking pin, 50. Rotatable shaft, 51. Right door right rear locking hole, 52. Right door side-folding rear locking hole, 53. Right door center-folding rear locking hole, 54. Right door left rear locking hole, 55. Left door right rear locking hole, 56. Left door rear center-folding locking hole, 57. Left door rear side-folding locking hole, 58. Left door rear left locking hole, 59. Beam's flat section, 60. Attachment holes and screws, 61. Rack connecting screw, 62. Hinge, 63. Locking fork, 64. Locking bracket, 65. Locking pin plunger, 66. T-Beam assembly, 67. Right rotatable beam, 68. Left rotatable beam, 69. Hinge, 70. T-beam center section, 71. Leg assembly, 72. T-beam leg attachment screw, 73. Right front pinion, right section, 74. Right rear pinion, right section, 75. Left front pinion, left section, 76. Left rear pinion, left section, 77. Right section front wall, 78. Right section rear wall, 79. Left section front wall, 80. Left section rear wall, 81. T-beam right fixed section, 82. T-beam left fixed section, 83. Right door right solenoid-actuator, 84. Right door left solenoid-actuator, 85. Right door gear motor, 86. Left door gear motor, 87. Left door right solenoid-actuator, 88. Left door left solenoid-actuator, 89. Right front pinion, left door, 90. Right rear pinion, left door, 91. Left front pinion, left door, 92. Left rear pinion, left door, 93. Right door flat-position proximity sensor, 94. Right door center-fold position proximity sensor, 95. Left door flat-position proximity sensor, 96. Left door center-fold position proximity sensor, 97. Right control handle 2^{nd} embodiment, 98. Left control handle 2^{nd} embodiment, 99. Right door power cable, 100. Left door power cable, 102. Hand grip, 103. Top screw, 104. Cable arm, 105. Bottom screw, 106. Right section top cover, 107. Right section bottom cover, 108. Cable assembly, 109. Left section top cover, 110. Left section bottom cover, 111. Right section right profile, 112. Right section left profile, 113. Left section right profile, 114. Left section left profile, 115. Right swiveling arm assembly, 116. Left swiveling arm assembly, 117. Pins extending spring, 118. Rotating ring, 119. Cable guiding rivet, 120. Swiveling arm boss, 121. Swiveling arm roller, 122. Swiveling arm roller axle, 123. Swiveling arm securing screw, 124. Cable fork, 125. Hinge, 126. Top seal, 127. Alternative right section left profile design, 128. Alternative left section right profile design, 129. Alternative top seal, 130. Pin's arm, 131. 2^{nd} embodiment control handle, 132. Lock, 133. Side button, 134. Center button, 135. Hand grip, 136. Power wire, 137. 1^{st} embodiment grip square recess, 138. Solenoid mounting bracket, 139. Cable loop, 140. 3^{rd} embodiment control handle, 141. Gear motors assemblies, 142. Gear motor pinion, 143. Rotating shaft gear, 144. Cable arm square boss, 145. Connecting tab, 146. Solenoid-actuator rod, 147. Gear motor bracket, 149. Side-R button, 150. Side-L button, 151. Center-R button, 152. Center-L button, 153. Cable arm stopping rivet, 154. Power cable from truck's battery

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A tonneau cover assembly for a vehicle, wherein the vehicle includes a passenger compartment, an open bed portion and a tailgate portion, comprising:
a first beam member attached to an upper surface of the bed portion;
wherein the first beam member includes an area defining a track formed therein;
wherein the first beam member includes an area defining an aperture formed in a surface thereof;
a first door assembly operable to cover at least a portion of the open bed portion;
wherein the first door assembly includes first and second door members;
wherein the first and second door members are hingedly interconnected so as to be operable to rotate about one another;
wherein at least one of the first and second door members includes a pin member received within a pinion member;
wherein the pinion member is operable to be received within the track and rotate on a toothed rack within the track;
wherein the pin member is operable to be received within and retracted from the aperture; and
an actuation member operably associated with the pin member;
wherein when the actuation member is in a first mode of operation, the pin member is received within the aperture so as to prevent the first and second door members from rotating about one another;
wherein when the actuation member is in a second mode of operation, the pin member is retracted from the aperture so as to allow the first and second door members to rotate about one another.

2. The tonneau cover assembly for a vehicle according to claim 1, further comprising:
a second beam member attached to a spaced and opposed upper surface of the bed portion proximate to the tailgate portion;
wherein the second beam member includes an area defining a track formed therein;
wherein the second beam member includes an area defining an aperture formed in a surface thereof;
wherein the pinion member is operable to be received within the track of the second beam member and rotate a toothed rack within the track;
wherein the pin member is operable to be received within and retracted from the aperture of the second beam member;
wherein when the actuation member is in the first mode of operation, the pin member is received within the aperture of the second beam member so as to prevent the first and second door members from rotating about one another;
wherein when the actuation member is in the second mode of operation, the pin member is retracted from the aperture of the second beam member so as to allow the first and second door members to rotate about one another.

3. The tonneau cover assembly for a vehicle according to claim 2, further comprising:
a third beam member attached to a left upper surface of the bed portion; and
a fourth beam member attached to a spaced and opposed right upper surface of the bed portion.

4. The tonneau cover assembly for a vehicle according to claim 3, further comprising:
a second door assembly operable to cover a second portion of the open bed portion;
wherein the second door assembly includes third and fourth door members;
wherein the third and fourth door members of the second door assembly are hingedly interconnected so as to be operable to rotate about one another;
wherein at least one of the third and fourth door members of the second door assembly includes a pin member received within a pinion member;
wherein the pinion member is operable to be received within the tracks of the first and second beam members and rotate a toothed rack within the track;
wherein the pin member is operable to be received within and retracted from the apertures of the first and second beam members; and
a second actuation member operably associated with the pin member;
wherein when the second actuation member is in a first mode of operation, the pin member is received within the apertures of the first and second beam members so as to prevent the third and fourth door members of the second door assembly from rotating about one another;
wherein when the second actuation member is in a second mode of operation, the pin member is retracted from the apertures of the first and second beam members so as to allow the third and fourth door members of the second door assembly to rotate about one another.

5. The tonneau cover assembly for a vehicle according to claim 1, wherein the first and second door members of the first door assembly are operable to be rotated about one another so as to be positioned towards a left or right portion of the bed portion.

6. The tonneau cover assembly for a vehicle according to claim 1, wherein the first and second door members of the first door assembly are operable to be rotated about one another so as to be positioned towards a centerline of the bed portion.

7. The tonneau cover assembly for a vehicle according to claim 2, wherein the second beam member is hingedly attached to the upper surface of the bed portion proximate to the tailgate portion.

8. The tonneau cover assembly for a vehicle according to claim 1, further comprising a center support member, wherein a lower portion is fastened to a bottom surface of the bed portion, wherein an upper portion includes two spaced and opposed end members hingedly attached to a center member.

9. The tonneau cover assembly for a vehicle according to claim 1, wherein the actuation member includes a solenoid member.

10. The tonneau cover assembly for a vehicle according to claim 1, wherein the actuation member includes a gear motor member.

11. A tonneau cover assembly for a vehicle, wherein the vehicle includes a passenger compartment, an open bed portion and a tailgate portion, comprising:
a first beam member attached to an upper surface of the bed portion proximate to the passenger cabin;
a second beam member attached to a spaced and opposed upper surface of the bed portion proximate to the tailgate portion;
wherein the first and second beam members include an area defining a track formed therein;
wherein the first and second beam members include an area defining an aperture formed in a surface thereof;
a first door assembly operable to cover at least a portion of the open bed portion;
wherein the first door assembly includes first and second door members;
wherein the first and second door members are hingedly interconnected so as to be operable to rotate about one another;
wherein at least one of the first and second door members includes a pin member received within a pinion member;
wherein the pinion member is operable to be received within the tracks of the first and second beam members and rotate on a toothed rack within the track;
wherein the pin member is operable to be received within and retracted from the apertures of the first and second beam members; and
an actuation member operably associated with the pin member;
wherein when the actuation member is in a first mode of operation, the pin member is received within the apertures of the first and second beam members so as to prevent the first and second door members from rotating about one another;
wherein when the actuation member is in a second mode of operation, the pin member is retracted from the apertures of the first and second beam members so as to allow the first and second door members to rotate about one another.

12. The tonneau cover assembly for a vehicle according to claim 11, further comprising:
a third beam member attached to a left upper surface of the bed portion; and
a fourth beam member attached to a right upper surface of the bed portion.

13. The tonneau cover assembly for a vehicle according to claim 12, further comprising:
a second door assembly operable to cover a second portion of the open bed portion;
wherein the second door assembly includes third and fourth door members;
wherein the third and fourth door members of the second door assembly are hingedly interconnected so as to be operable to rotate about one another;
wherein at least one of the third and fourth door members of the second door assembly includes a pin member received within a pinion member;
wherein the pinion member is operable to be received within the tracks of the first and second beam members and rotate on a toothed rack within the track;
wherein the pin member is operable to be received within and retracted from the apertures of the first and second beam members; and
a second actuation member operably associated with the pin member;
wherein when the second actuation member is in a first mode of operation, the pin member is received within the apertures of the first and second beam members so as to prevent the third and fourth door members of the second door assembly from rotating about one another;
wherein when the second actuation member is in a second mode of operation, the pin member is retracted from the apertures of the first and second beam members so as to allow the third and fourth door members of the second door assembly to rotate about one another.

14. The tonneau cover assembly for a vehicle according to claim 13, wherein the first and second door members of the first door assembly or the third and fourth door members of the second door assembly are operable to be rotated about one another so as to be positioned towards the left or right portion of the bed portion.

15. The tonneau cover assembly for a vehicle according to claim 13, wherein the first and second door members of the first door assembly or the third and fourth door members of the second door assembly are operable to be rotated about one another so as to be positioned towards a centerline of the bed portion.

16. The tonneau cover assembly for a vehicle according to claim 11, wherein the second beam member is hingedly attached to the upper surface of the bed portion proximate to the tailgate portion.

17. The tonneau cover assembly for a vehicle according to claim 11, further comprising a center support member, wherein a lower portion is fastened to a bottom surface of the bed portion, wherein two spaced and opposed end members of the second beam member are hingedly attached to a center portion of the center support member.

18. The tonneau cover assembly for a vehicle according to claim 11, wherein the actuation member includes a solenoid member.

19. The tonneau cover assembly for a vehicle according to claim 11, wherein the actuation member includes a gear motor member.

20. A tonneau cover assembly for a vehicle, wherein the vehicle includes a passenger compartment, an open bed portion and a tailgate portion, comprising:
a first beam member attached to an upper surface of the bed portion proximate to the passenger cabin;
a second beam member attached to a spaced and opposed upper surface of the bed portion proximate to the tailgate portion;
a third beam member attached to a left upper surface of the bed portion;
a fourth beam member attached to a spaced and opposed right upper surface of the bed portion;
wherein the first and second beam members include an area defining a track formed therein;
wherein the first and second beam members include an area defining an aperture formed in a surface thereof;
a first door assembly operable to cover a first portion of the open bed portion;
wherein the first door assembly includes first and second door members;
wherein the first and second door members are hingedly interconnected so as to be operable to rotate about one another;
wherein at least one of the first and second door members includes a pin member received within a pinion member;
wherein the pinion member is operable to be received within the tracks of the first and second beam members and rotate on a toothed rack within the track;
wherein the pin member is operable to be received within and retracted from the apertures of the first and second beam members; and
a first actuation member operably associated with the pin member;
wherein when the first actuation member is in a first mode of operation, the pin member is received within the apertures of the first and second beam members so as to prevent the two door members from rotating about one another;
wherein when the first actuation member is in a second mode of operation, the pin member is retracted from the apertures of the first and second beam members so as to allow the first and second door members to rotate about one another;
a second door assembly operable to cover a second portion of the open bed portion;
wherein the second door assembly includes third and fourth door members;
wherein the third and fourth door members of the second door assembly are hingedly interconnected so as to be operable to rotate about one another;
wherein at least one of the third and fourth door members of the second door assembly includes a pin member received within a pinion member;
wherein the pinion member of the third or fourth door members is operable to be received within the tracks of the first and second beam members and rotate on a toothed rack within the track;
wherein the pin member of the third or fourth door members is operable to be received within and retracted from the apertures of the first and second beam members; and
a second actuation member operably associated with the pin member of the third or fourth door members;
wherein when the second actuation member is in a first mode of operation, the pin member of the third or fourth door members is received within the apertures of the first and second beam members so as to prevent the third and fourth door members of the second door assembly from rotating about one another;
wherein when the second actuation member is in a second mode of operation, the pin member of the third and fourth door members is retracted from the apertures of the first and second beam members so as to allow the third and fourth door members of the second door assembly to rotate about one another.

21. The tonneau cover assembly for a vehicle according to claim 20, wherein the first and second door members of the first door assembly or the third and fourth door members of the second door assembly are operable to be rotated about one another so as to be positioned towards the left or right portion of the bed portion.

22. The tonneau cover assembly for a vehicle according to claim 20, wherein the first and second door members of the first door assembly or the third and fourth door members of the second door assembly are operable to be rotated about one another so as to be positioned towards a centerline of the bed portion.

23. The tonneau cover assembly for a vehicle according to claim 20, wherein the second beam member is hingedly attached to the upper surface of the bed portion proximate to the tailgate portion.

24. The tonneau cover assembly for a vehicle according to claim 20, further comprising a center support member, wherein a lower portion is fastened to a bottom surface of the bed portion, wherein two spaced and opposed end members of the second beam member are hingedly attached to a center portion of the center support member.

25. The tonneau cover assembly for a vehicle according to claim 20, wherein the first or second actuation member includes a solenoid member.

26. The tonneau cover assembly for a vehicle according to claim 20, wherein the first or second actuation member includes a gear motor member.
